(19) United States
(12) Patent Application Publication
(10) Pub. No.: US 2017/0226775 A1
(43) Pub. Date: Aug. 10, 2017

(54) Device for Locking or Releasing a Safety-Relevant, Movable Component in a Controlled Manner

(71) Applicant: Euchner GmbH + Co. KG, Leinfelden-Echterdingen (DE)

(72) Inventor: Bernd Hermann, Rottenburg (DE)

(21) Appl. No.: 15/503,422

(22) PCT Filed: Jul. 24, 2015
(86) PCT No.: PCT/EP2015/067021

§ 371 Date: Feb. 13, 2017

(30) Foreign Application Priority Data
Oct. 17, 2014 (DE) 10 2014 015 389.4

(51) Int. Cl. E05B 47/00; E05B 47/02

(52) U.S. Cl. CPC E05B 47/0012; E05B 47/026; E05B 2047/0022; E05B 2047/0036; E05B 2047/0086

(57) ABSTRACT

A device for a controlled locking or release of a safety-relevant, movable component (2), such as a protective door, protective cover of the like, with a movable blocking element (51) and with a self-locking drive unit (5, 17, 19, 21, 23, 27) controlling adjustment movements of the blocking element (51) between a locked position and a released position is characterized in that an actuator (33) is provided that can be moved by the drive unit (5, 17, 19, 21, 23, 27), said actuator being mechanically coupled to the blocking element for a transfer of the blocking element (51) into the released position brought about by the drive unit (5, 17, 19, 21, 23, 27) and being capable of decoupling for a transfer of the blocking element (51) into the released position brought about independently of the drive unit (5, 17, 19, 21, 23, 27).

### CROSS REFERENCE TO RELATED APPLICATIONS

This application is the U.S. national stage of International Application No. PCT/EP2015/067021, filed on Jul. 24, 2015. The international application claims the priority of DE 102014015389.4 filed on Oct. 17, 2014; all applications are incorporated by reference herein in their entirety.

### BACKGROUND

The invention relates to a device for locking or releasing in a controlled manner a safety-relevant, movable component, such as a protective door, protective cover or the like, with a movable blocking element and with a self-locking drive unit controlling adjustment movements of the blocking element between the locked position and the released position.

Devices of this type exist in the prior art and are preferably used in units that form a part of a safety system in which movable components can be locked into a position in which they create a boundary preventing entry or access for an area to be protected, for instance in the form of a protective door or protective cover as a protective device in the danger zone of a machine. A device of the type mentioned at the outset is disclosed in the document DE 10 2009 041 101 A1. This document shows two variants of a locking device; a rotary drive unit with an electric motor is provided in each case. In one case, a spur gear is located on the drive shaft of the electric motor that engages with rack-type teeth on the blocking element, which is designed in the form of a retaining pin that can be axially moved into the locked position or released position via the rotary movements of the electric motor in one direction or the other. This design of the drive unit with the gear wheel/gear racks/gear system directly connected to the motor drive shaft is, in deviation from the type mentioned at the outset, not self-locking. This means that the retaining pin is movable in an undesirable way, for instance when there is vibration or shock stress, and can be moved out of the locked position into the released position, as an example, in the case of an electric motor that is not supplied with electrical energy or a functional failure of the electric motor. This is not acceptable with regard to locking units for safety-relevant components.

A second device variant of this type that is shown in the above-mentioned document avoids this safety deficiency by providing a gear arrangement between the electric motor and the blocking element that has a worm gear and a toggle-element assembly. Since a gear arrangement of that kind is self-locking, a risk is in fact avoided that the blocking element will be moved from the locked position into the released position when there is a failure of the drive unit, and that an unintended release will come about because of that, but the drawback that actuation will not be possible when there is a failure of the drive unit in the sense of emergency actuation, in which entry or access to the bordered area will be required to make a so-called emergency release possible, has to be accepted.

### SUMMARY

A device for a controlled locking or release of a safety-relevant, movable component (2), such as a protective door, protective cover of the like, with a movable blocking element (51) and with a self-locking drive unit (5, 17, 19, 21, 23, 27) controlling adjustment movements of the blocking element (51) between a locked position and a released position is characterized in that an actuator (33) is provided that can be moved by the drive unit (5, 17, 19, 21, 23, 27), said actuator being mechanically coupled to the blocking element for a transfer of the blocking element (51) into the released position brought about by the drive unit (5, 17, 19, 21, 23, 27) and being capable of decoupling for a transfer of the blocking element (51) into the released position brought about independently of the drive unit (5, 17, 19, 21, 23, 27).

### DETAILED DESCRIPTION

In view of these problems, the invention takes on the task of providing a device of the type mentioned at the outset that avoids the above-mentioned safety deficiencies of the prior art.

This problem is solved as per the invention with a device that has the features of claim 1 in its entirety.

In accordance with the characterizing portion of claim 1, an important special feature of the invention is that an actuator is provided that can be moved by a self-locking drive unit; the actuator is mechanically coupled to the blocking element for a transfer of the blocking element into the released position brought about by the drive unit and is decoupled from the blocking element for a transfer into the released position that is brought about independently of the drive unit. The use of a self-locking gear system in combination with the possibility of decoupling between the actuator and the blocking element provided by the invention prevents, for one thing, unintended unlocking when there is a malfunction of the drive unit and when force acts on the blocking element. Furthermore, the decoupling possibility between the actuator and the blocking element offered as per the invention also avoids a safety risk in hazardous situations by enabling an emergency release that takes place independently of the drive unit.

The device as per the invention can be designed in a particularly advantageous way in the form of a pin retention unit with a blocking element in the form of a retaining pin that is mounted in a coaxial fashion with regard to a linear displacement movement of the actuator for its movements between the locked position and the released position and is preloaded into the locked position via an energy storage device.

A rotary drive unit with a gear system converting the rotary movement of the drive shaft of an electric motor into linear movements of the actuator coaxial to the axis of the drive shaft can be provided for the device.

In the case of a drive unit of that type with an electric motor, a planetary gear train and a spindle drive unit that can be driven by it and that moves the actuator between advanced and retracted positions can be provided in an especially advantageous way as a gear system that gives the drive unit the self-locking feature. The use of a planetary gear train as a component of the gear system makes it possible to transfer high torques in a very small space; at the same time, high gear ratios can be realized and this makes an especially compact design of the fixed housing of the device possible in combination with a spindle drive unit, so it can be integrated into safety-related systems without difficulty even when a small installation space is available.

A tappet in the form of a rod that extends into a central through-hole of the housing of the locking unit can be provided as an actuator as a special advantage.

In so doing, the arrangement can be advantageously configured in such a way that the tappet has a projecting follower on the end turned away from the drive unit that works together with a contact surface on the retaining pin to transfer its retracting movement; a decoupling path is formed on the retaining pin over the length of which the retaining pin can be moved from the locked position into the released position against the applied preload force of the energy storage device with a follower that is lifted from the contact surface. The retaining pin, which is in the advanced locked position, is decoupled from the follower of the tappet such that it can be moved from the locked position into the released position against the preload force acting on it if necessary, regardless of the axial position that the tappet assumes. In especially advantageous design examples, the retaining pin has a sleeve element axially extending in the direction of the drive unit in which a guideway is formed as a decoupling path for the follower of the tappet over the length of which the retaining pin can be moved in an axial fashion relative to the follower against the preload force of the energy storage device.

The arrangement can, with a special advantage, be configured in such a way here that the retaining pin is held in the open end of the housing with a radially projecting flange element that is connected to the sleeve element, which is surrounded by a recoil spring provided as an energy storage device in the form of a coil spring that is supported on the flange element, on the one hand, and on a step in the through-hole of the housing, on the other hand. The locking unit can be realized in an especially compact design in this way.

An emergency release device can be provided for an escape or emergency release of the locking unit that is to be carried out if the need arises via which the retaining pin can be manually moved from the locked position into the released position against the effect of the coil spring with a lifting of the follower of the tappet from the contact surface. In an advantageous embodiment, the emergency release device can have an emergency button connected to an actuation rod that can be moved crosswise to the axis in the housing, said actuation rod having slanted surfaces on the end extending into the housing through-hole that act on a protruding flange edge of the sleeve element of the retaining pin when the emergency button is pressed to move it against the effects of the coil spring.

### BRIEF DESCRIPTION OF THE DRAWINGS

The invention will be explained in detail below with the aid of an example presented in the drawing. The following are shown in the figures:

FIG. 1 shows a diagonal view in perspective of the rotary drive unit for an example of the device as per the invention without an accompanying locking unit;

FIG. 2 shows the individual parts of the rotary drive unit of the example in a diagonal view in perspective and an exploded view;

FIG. 3 shows a diagonal view in perspective of a longitudinal cutaway section of the drive unit;

FIG. 4 shows a diagonal view in perspective of a longitudinal cutaway section of the example, wherein the drive unit is shown in a broken view and the locking unit is shown in the form of a pin retention unit with a locked protective door;

FIG. 5 shows a view corresponding to FIG. 4, wherein a released state is shown;

FIG. 6 shows a view corresponding to FIGS. 4 and 5, wherein an emergency release state is shown;

FIG. 7 shows a schematically simplified, partial longitudinal section with a sectional plane rotated with respect to FIGS. 4 to 6, wherein the locked state is presented of the door, which is only suggested in the diagram; and

FIG. 8 shows a partial longitudinal section corresponding to FIG. 7 but with a broken view, wherein the state of the emergency release shown in FIG. 6 is presented.

### DETAILED DESCRIPTION OF THE PREFERRED EMBODIMENTS

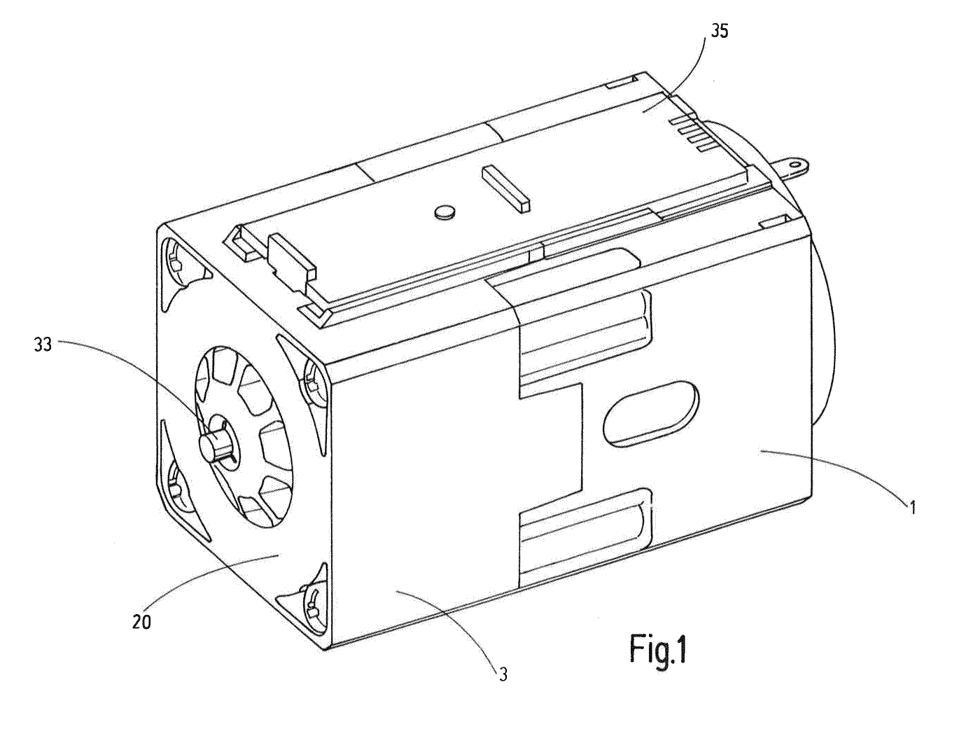

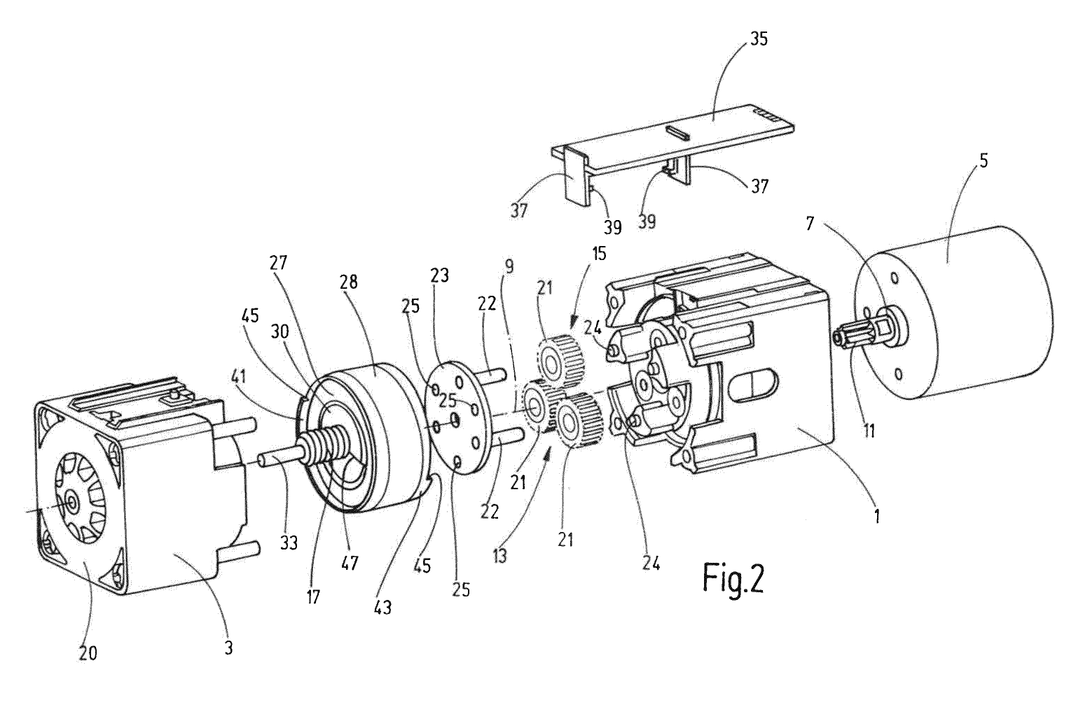

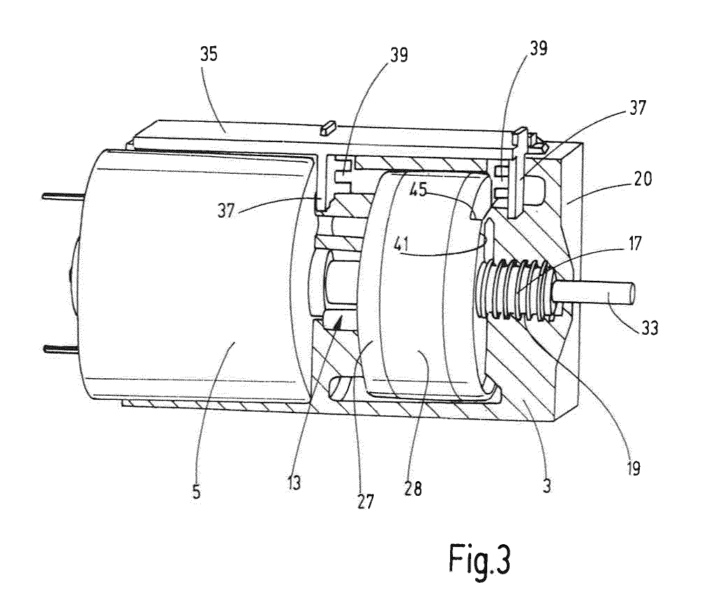

With reference to the drawing, the invention will be explained with the example of a locking unit in the form of a pin retention unit for a protective door; a rotary drive unit with an electric motor 5 is provided. This drive unit that is shown in FIGS. 1 to 3 without an accompanying locking unit has a drive unit housing that is made up of housing parts 1 and 3 and that has the shape of a rectangular parallelepiped with a square cross-section in the closed state shown in FIG. 1. FIGS. 2 and 3 show more detail of the drive unit. The housing part 1 situated on the right-hand side in FIG. 2 constitutes the motor housing for the electric motor 5, which is mounted in the housing part 1 in such a way that its drive shaft 7 extends along the central longitudinal axis 9 of the housing parts 1, 3. A pinion 11 is located on the drive shaft 7. The housing parts 1 and 3 that are assembled into the drive unit housing form a gear housing 13 between themselves for a planetary gear train 15 and a gear spindle 17. The latter is engaged with an internal thread 19 that is located in the end wall 20 of a housing part 3 forming a spindle housing.

The planetary gear train 15 has three planetary gears 21 that are engaged with the pinion 11 that forms the sun gear. The planetary gears 21 are mounted with a locally fixed axis of rotation on the bearing journal 22 of a planetary carrier 23. The planetary carrier 23 in the form of a circular plate is attached in a fixed way to the protruding studs 24 of the housing part 1, which engage with the stud holes 25 of the planetary carrier 23. A ring gear 27 that forms, together with the gear spindle 17, a one-piece component is provided as a gear element of the planetary gear train 15 on the output side. The ring gear 27 has a circular cylindrical case 28 that surrounds a pot 29; the gear spindle 17 extends as a coaxial projection from the pot base 30. The inner wall of the pot 29 has teeth 31 that the planetary gears 21 mesh with. The axial length of the case 28 and therefore the axial length of the teeth 31 are chosen in such a way that the teeth 31 remain meshed with the planetary gears 21, whereas the gear spindle 17 moves over an operational stroke or displacement path during the rotary movement of the drive unit generated by the planetary gears 21. A tappet 33, see FIG. 1, that extends outside through the end wall 20 of the housing part 3 is attached in the form of a coaxial projection to the gear spindle 17 as an actuator that transfers, depending on the rotary direction of the electric motor 5 in the forward or reverse direction, linear displacement movements of the ring gear 27 that are coaxial to the drive shaft 7 to the locking unit to be controlled, which is not shown in FIGS. 1 to 3.

An electronic control unit in line with the prior art that controls the operation of the electric motor 5 in the two rotary directions has a circuit board 35 that is on top of the housing. As FIGS. 2 and 3 show, carriers 37, each of which has a light barrier located on it, extend from the board 35 into the gear housing 13. An axially projecting edge rib 41 is formed on the front peripheral edge of the case 28 of the ring gear 27 and an axially projecting edge rib 43 is formed on its rear peripheral edge that each have a spiral pattern, so a shoulder 45 is formed in each case on them, to create a sensor device that evaluates the signals of the light barriers 39 connected to the circuit board 35. When approaching the front end position of the actuation displacement movement, the edge rib 41, which is connected to the shoulder 45, runs into the light path of the light barrier 39 for position detection. During the return movement, the part of the edge rib 43 connected to the shoulder 45 runs into the light path of the assigned light barrier 39 during the approach to the end position, in order to once again generate a position signal. When mechanical stops are provided for the end positioning of the ring gear 27 and therefore of the tappet 33 forming the actuator, the signals of the light barriers 39 can bring about a braking or slowdown of the motor 5 before the mechanical stops are reached. As an alternative to the light barriers 39 influenced by the edge ribs 41 and 43, a light-dark contrast could be used on the outside of the case 28 of the ring gear 27 for optical position detection.

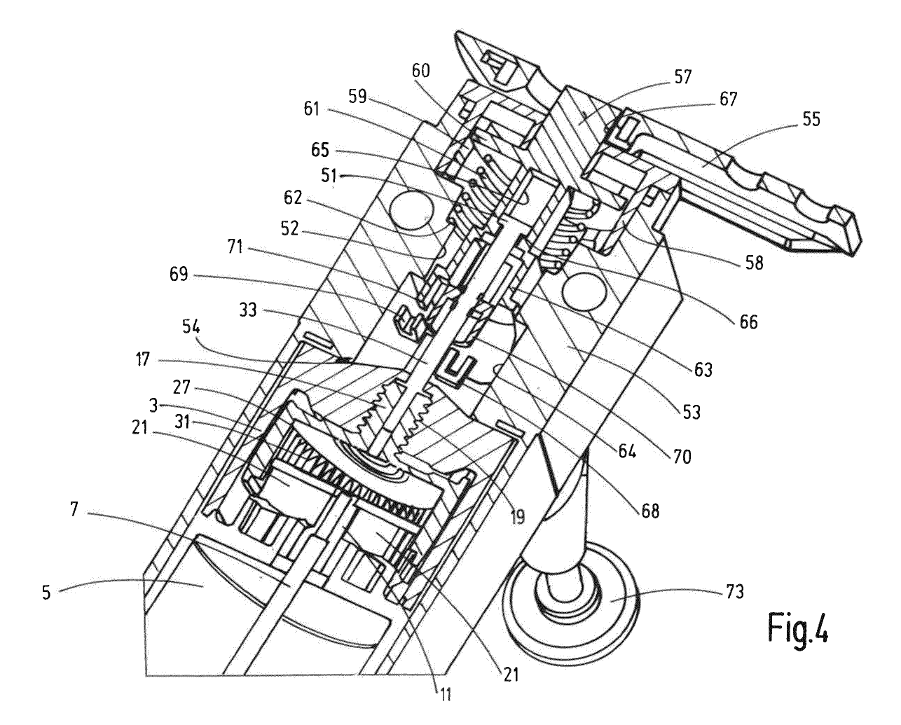

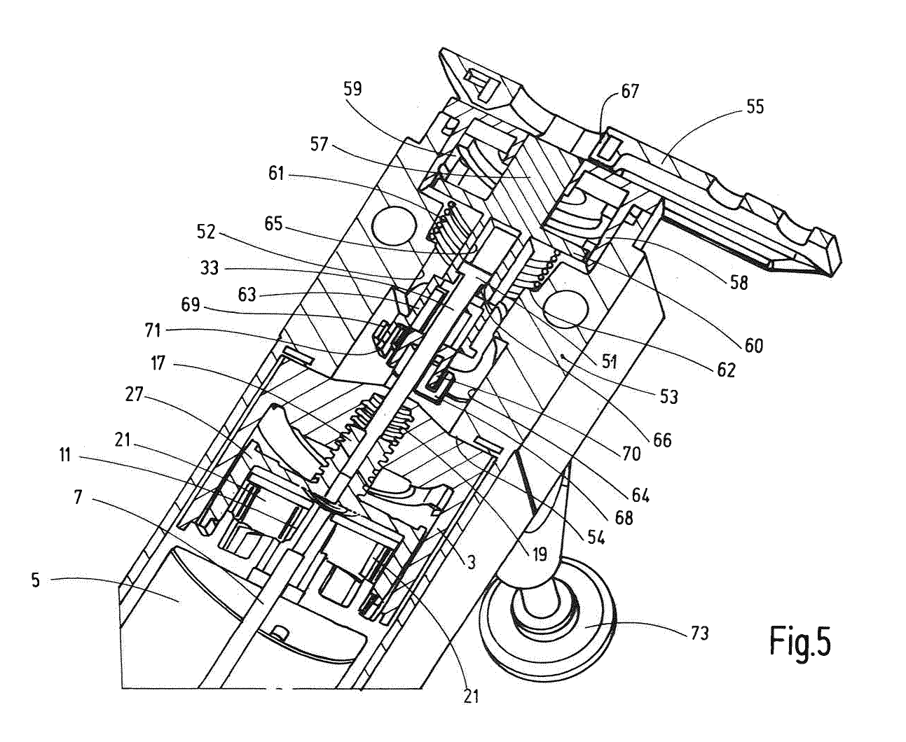

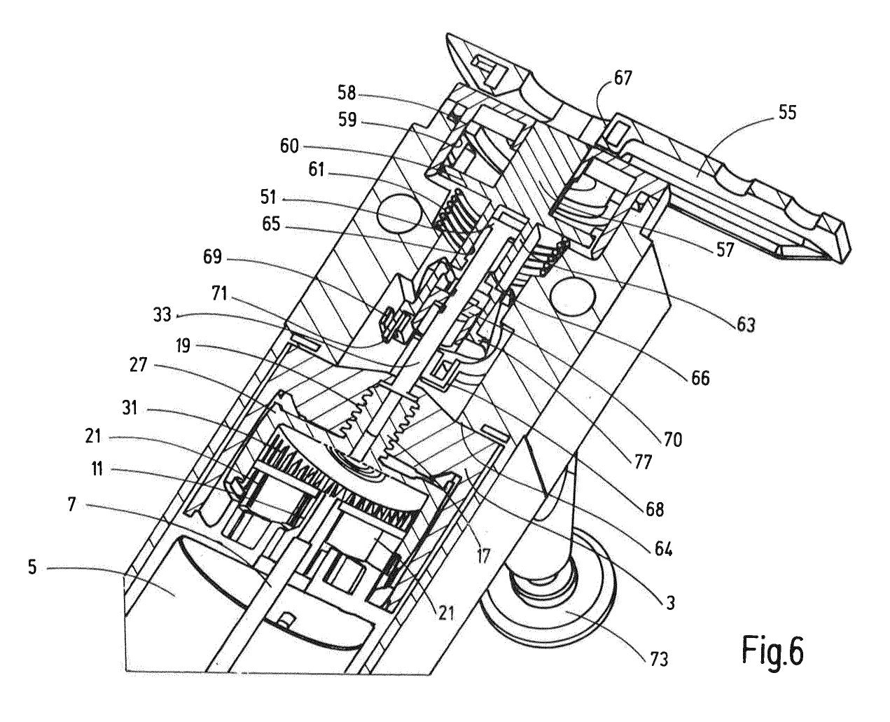

FIGS. 4 to 8 show an example of a locking unit in the form of a pin retention unit. To control the locking unit, the tappet 33 forming the axially movable actuator has the shape of a fairly long rod that ends in a radially projecting follower 51 and that extends into a central through-hole 52 of the housing 53 of the locking unit. The drive unit with the drive unit housing made up of the housing parts 1, 3 is inserted into the housing 53, which surrounds the housing part 3 from its open end 54, at the open end 54 of the through-hole 52. The locking unit has a retaining pin 57, which can be moved between the locked position and the released position coaxially to the axis of the linear movement of the tappet 33, for the locking or release of a protective door 55, which is merely suggested in terms of an edge section in FIGS. 4 to 8. The retaining pin 57 is shown in the forward locked position in FIG. 4 and in the retracted released position in FIGS. 5 and 6.

The retaining pin 57 is guided in a guide element 58 that is inserted into the free, open end of the through-hole 52 of the housing 53 and that surrounds a hollow cylinder 59 in which the retaining pin 57 with a radially projecting flange element 60 is guided. A recoil spring 61 that is mounted on the flange element 60 and on a step 62 of the through-hole 52 preloads the retaining pin 57 for a movement into the locked position shown in FIG. 4. Starting from the flange element 60, the retaining pin 57 continues with a sleeve element 63 that extends through the recoil spring 61 to an extended end section 64 of the through-hole 52. In the initial part connected to the flange element 60, the sleeve element 63 forms a guideway 65 for the follower 51 of the tappet 33 that is limited by a contact surface 66 for the follower 51 projecting radially inward at the end that is distant from the flange element 60.

FIG. 4 shows the locked state in which the retaining pin 57 is advanced into the bolt opening 67 of the door 55 by the preload force of the spring 61. The tappet 33 is in the extended position; its follower 51 makes contact with the contact surface 66. If the tappet 33 is retracted for a transition to the released state, its follower 51 making contact with the contact surface 66 takes the retaining pin 57 along into the released position against the force of the recoil spring 61. This operating state is shown in FIG. 5. Light barriers 68 and 69 are arranged in the extended end section 64 of the through-hole 52 for the detection of the positions that are assumed in connection with this by the tappet 33 and the retaining pin 57. In the state of FIG. 5, a cup-like collar 70 that is attached to the tappet 33 interrupts the light path of the light barrier 68, whereas an end part 71 laterally projecting at the end of the sleeve element 63 interrupts the light path of the light barrier 69.

The state shown in FIG. 5 represents the case of a “normal release” in which the retaining pin 57 is retracted against the force of the recoil spring 61 by the return movement of the tappet 33 generated by the actuation device. The locking unit makes an emergency release possible when there is a failure of the actuation device. This operating state in which the tappet 33 remains in the advanced position is shown in FIG. 6. As shown there, a decoupling path is formed for a movement of the retaining pin 57 against the spring force through the length of the guideway 65 that is made available in the sleeve element 63 for relative movements to the follower 61. The retaining pin 57 can be moved over the length of the decoupling path into the released position; the follower 51 of the tappet 33 lifts off the contact surface 66 in the process. In so doing, the released state of the retaining pin 57 is signaled, just as in the case of the “normal release” of FIG. 5, by the end part 71 interrupting the light path of the light barrier 69. Unlike the case in FIG. 5, however, the advanced state of the tappet 33 is signaled by the light path of the light barrier 68 not being interrupted. The device as per the invention can interact with RFID technology, which is known in and of itself, with an actuator (not shown) arranged on the respective, safety-relevant, movable component (protective door or protective cover) that passes along at least one message to the device and its control parts, in particular with regard to the opened or closed state.

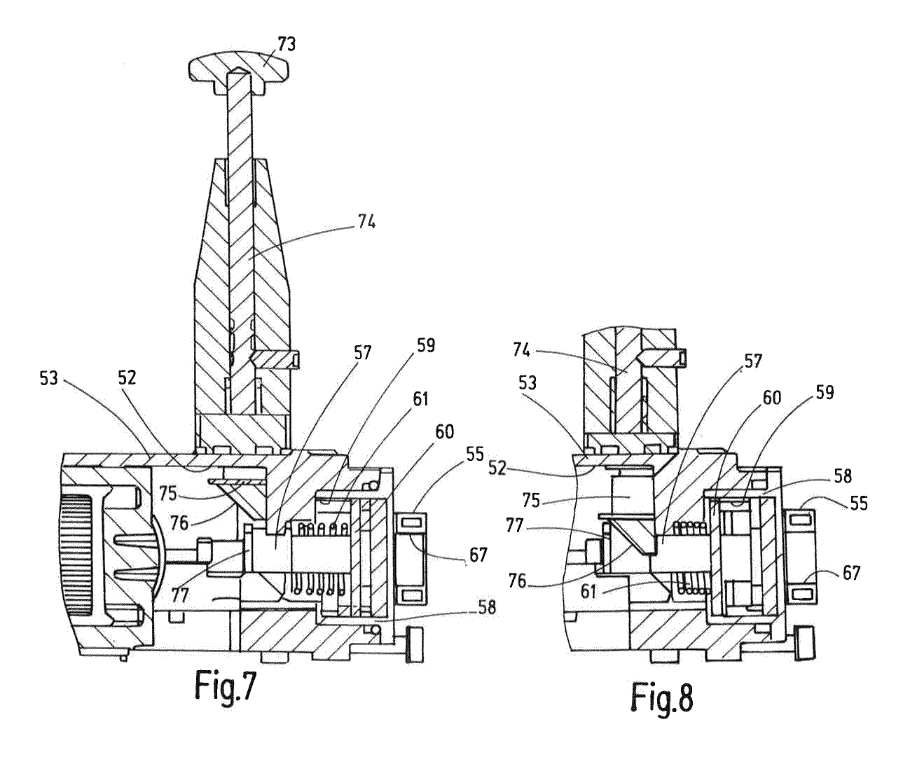

FIGS. 7 and 8 show, in a schematically simplified depiction, an emergency release device via which an emergency release can be manually carried out. The emergency release device has an emergency button 73 that is connected to an actuation rod 74. It has an actuation fork 75 on the end extending into the housing through-hole 52 that overlaps the sleeve element 63 of the retaining pin 57 and that has slanted control surfaces 76, which are applied to a projecting flange edge 77 on the retaining pin 57 when the emergency button 73 is pressed and pull it back against the effect of the spring 61 into the released position, as a comparison of FIGS. 7 and 8 shows.

1. A device for a controlled locking or release of a safety-relevant, movable component (55), such as a protective door, protective cover of the like, with a movable blocking element (57) and with a self-locking drive unit (5, 17, 19, 21, 23, 27) controlling adjustment movements of the blocking element (57) between a locked position and a released position, comgrising an actuator (33) that can be moved by the drive unit (5, 17, 19, 21, 23, 27), said actuator being mechanically coupled to the blocking element for transfer of the blocking element (57) into the released position brought about by the drive unit (5, 17, 19, 21, 23, 27) and being capable of decoupling for transfer of the blocking element (57) into the released position brought about independently of the drive unit (5, 17, 19, 21, 23, 27).

2. The device according to claim 1, wherein it has a locking unit (53) in the form of a pin retention unit with the blocking element in the form of a retaining pin (57) that is mounted coaxially to a linear displacement movement of the actuator (33) for its movements between the locked position and the released position and is preloaded into the locked position via an energy storage device (61).

3. The device according to claim 1, wherein a rotary drive unit (5, 17, 19, 21, 23, 27) is provided with a gear system (15) converting rotary movement of a drive shaft (7) of an electric motor (5) into linear movements of the actuator (33) coaxial to the axis (9) of the drive shaft (7).

4. The device according to claim 1, wherein a planetary gear train (15) and a spindle drive unit (17) that can be driven by said planetary gear train and that moves the actuator (33) between advanced and retracted positions are provided.

5. The device according to claim 1, wherein a tappet (33) constituting the actuator is provided in the form of a rod that extends into a central through-hole (52) of a housing (53) of a locking unit.

6. The device according to claim 1, wherein a tappet (33) has a follower (51) at the end turned away from the drive unit (5, 17, 19, 21, 23, 27), said follower interacting with a contact surface (66) located on a retaining pin (57) to transfer the return movement of the follower, and that a decoupling path (65) is formed on the retaining pin (57), wherein the retaining pin (57) can be moved over the length of the decoupling path with the follower (51) lifted off the contact surface (66) from the locked position into the released position against an applied preload force of n energy storage device (61).

7. The device according to claim 1, wherein a retaining pin (57) has a sleeve element (63) axially extending in the direction of the drive unit (5, 17, 19, 21, 23, 27) in which a guideway (65) is formed as a decoupling path for a follower (51) of a tappet (33), wherein the retaining pin (57) can be axially moved relative to the follower (51) over the length of the guideway against a preload force of an energy storage device (61).

8. The device according to claim 1, wherein a retaining pin (57) is held in the open end of a housing (53) with a radially projecting flange element (60) that is connected to a sleeve element (63), which is surrounded by a recoil spring provided as an energy storage device in the form of a coil spring (61) that is supported on the flange element (60) and on a step (62) in a through-hole (52) of the housing (53).

9. The device according to claim 1, wherein an emergency release device (73 to 77) is provided via which a retaining pin (57) can be manually moved from the locked position into the released position against the effect of a coil spring (61) with a lifting of a follower (61) of a tappet (33) from a contact surface (66).

10. The device according to claim 1, wherein an emergency release device has an emergency button (73) connected to a rod (74) that can be moved crosswise to the axis (9) in a housing (53), said rod having slanted surfaces (76) on the end extending into a housing through-hole (52) that act on a protruding flange edge (77) of a sleeve element (63) of a retaining pin (57) when the emergency button (73) is pressed to move it against the effects of a coil spring (61).
